(19) United States
(12) Patent Application Publication
(10) Pub. No.: US 2025/0303897 A1
(43) Pub. Date: Oct. 2, 2025

(54) VEHICLE CHARGING APPARATUS

(71) Applicant: YAZAKI CORPORATION, Tokyo (JP)

(72) Inventors: Yukinari Naganishi, Susono-shi (JP); Shigeru Yoneda, Susono-shi (JP); Takashi Shiroki, Susono-shi (JP)

(21) Appl. No.: 19/234,235

(22) Filed: Jun. 10, 2025

Related U.S. Application Data
(63) Continuation of application No. PCT/JP2024/033369, filed on Sep. 19, 2024.

(30) Foreign Application Priority Data
Oct. 24, 2023 (JP) 2023-182171

(51) Int. Cl. B60L 53/30

(52) U.S. Cl. CPC B60L 53/30

(57) ABSTRACT

The vehicle charging apparatus includes a second cover surrounding a connector unit from a forwarding direction side of the sliding body, and a third covers arranged to face each other with a gap in the second direction, wherein the connector unit is arranged between the third covers. The second cover and a pair of third covers form a movable frame which extends upwards in conjunction with a swinging motion of arms when the arms rise, and surrounds the arms which are in a rising position. The second cover is provided with a first buffer member that has flexibility at least its upper end and can come into contact with the vehicle before the upper end. The pair of the third covers are provided with second buffer members that have flexibility at least at respective upper ends and can come into contact with the vehicle before the upper ends.

### CROSS-REFERENCE TO RELATED APPLICATION(S)

This application is a continuation application of International Application No. PCT/JP2024/033369 filed on Sep. 19, 2024 which claims the benefit of priority from Japanese Patent Application No. 2023-182171 filed on Oct. 24, 2023 and designating the U.S., the entire contents of which are incorporated herein by reference.

### BACKGROUND OF THE INVENTION

### 1. Field of the Invention

The present invention relates to a vehicle charging apparatus.

### 2. Description of the Related Art

Vehicle charging apparatuses feed power to a secondary battery of a vehicle that utilizes a rotary machine as a driving source, and charges the secondary battery. A vehicle charging apparatus, which is installed on a floor portion of a vehicle stopping space and feeds power from a power feeding apparatus to a vehicle stopped at the stopping space, is known. In this type of vehicle charging apparatus, the power feeding apparatus is provided with a power feeding fitting body to be fitted and connected to a power receiving fitting body of the vehicle (e.g. JP 2022-026 379 A).

Then, this vehicle charging apparatus opens an external cover that hides the power feeding apparatus when feeding power to the vehicle stopped in the stopping space, and presses up the power feeding fitting body together with a power feeding side component to fit and connect with the power receiving fitting body. Thus, it is desirable for this vehicle charging apparatus to avoid a contact of the power feeding side component with the vehicle side when pressing up the power feeding fitting body, in order to avoid quality degradation due to an interference between the power feeding component and the vehicle side. Otherwise, it is preferable to reduce the effect of the contact.

### SUMMARY OF THE INVENTION

An object of the present invention is therefore to provide the vehicle charging apparatus capable of reducing quality deterioration due to the contact of the power feeding side component.

In order to achieve the above mentioned object, a vehicle charging apparatus according to one aspect of the present invention includes a main body fixed to a floor portion of a stopping space for stopping a vehicle; a sliding body which can slide in a first direction with respect to the main body and forwards toward one side in the first direction when power is fed; a connector unit provided with a power feeding connector to be connected to the vehicle and arms, wherein the arms are swingably supported at base end portions at one end by the sliding body and support the connector at distal end portions at another end; a first cover that covers the connector unit from above with the sliding body housed in the main body, and covers the arms from a side opposite to a forwarding direction of the sliding body while swinging in conjunction with a swinging motion of the arms when the arms rise; a second cover that is supported by the sliding body and surrounds the connector unit from the forwarding direction side; and third covers that are supported by the sliding body, and respectively arranged to face each other with a gap in a second direction perpendicular to each of the first direction and a vertical direction, wherein the connector unit is arranged between the third covers, wherein the second cover and a pair of the third covers extend upwards in conjunction with the swinging motion of the arms when the arms rise, and form a movable frame surrounding the arms which are in a rising position, the second cover is provided, at least at an upper end of the second cover, with a first buffer member that has flexibility and can come into contact with the vehicle before the upper end, and the pair of third covers are provided, at least at respective upper ends of the third covers, with a second buffer members that have flexibility and can come into contact with the vehicle before the upper ends.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a vehicle charging apparatus according to an embodiment;

FIG. 2 is a perspective view illustrating an internal configuration of the vehicle charging apparatus according to the embodiment;

FIG. 3 is a side view illustrating the vehicle charging apparatus according to the embodiment;

FIG. 4 is an exploded view of a housing as viewed from a side;

FIG. 5 is a side view of the housing;

FIG. 6 is a side view of the housing;

FIG. 7 is a perspective view illustrating the vehicle charging apparatus according to the embodiment; and

FIG. 8 is a perspective view illustrating the vehicle charging apparatus according to the embodiment.

### DETAILED DESCRIPTION OF THE PREFERRED EMBODIMENTS

Hereinafter, an embodiment of a vehicle charging apparatus according to the present invention will be described in detail with reference to drawings. Note that the present invention is not limited by the embodiment.

### Embodiment

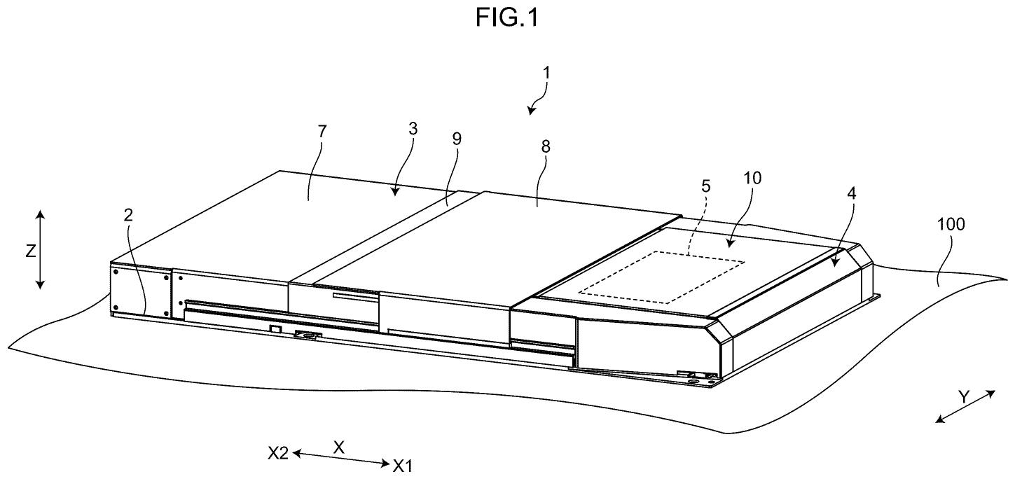

One of the embodiments of a vehicle charging apparatus according to the present invention will be described with reference to FIGS. 1 to 8.

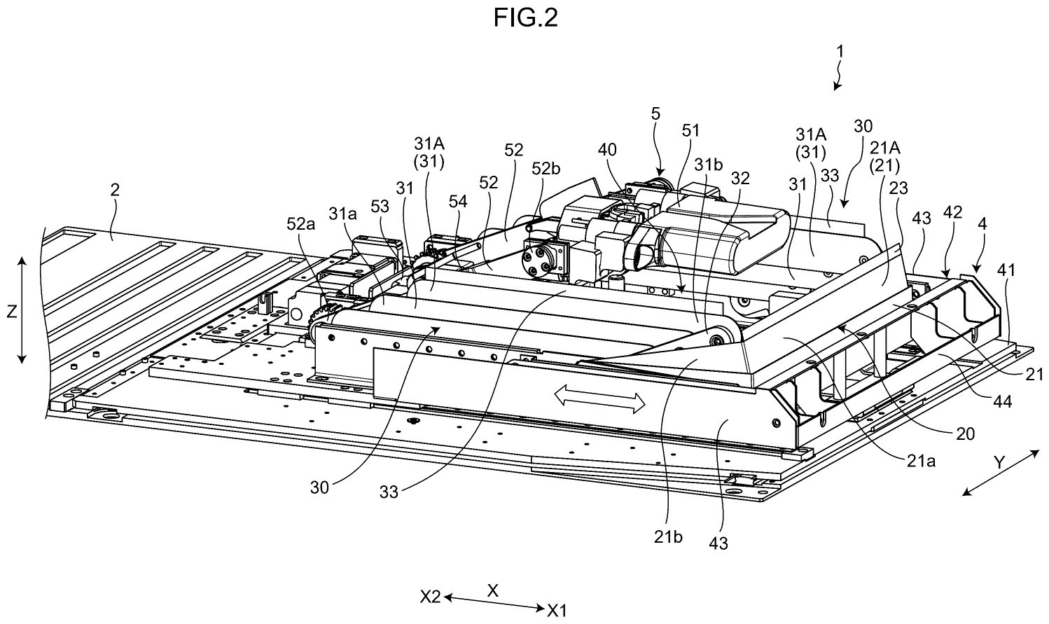

Reference numeral 1 in FIGS. 1 to 8 denotes the vehicle charging apparatus according to the present embodiment. The vehicle charging apparatus 1 is installed on a floor portion 100 of a stopping space for a vehicle to stop (FIG. 1). The floor portion 100 is a power feeding position of the vehicle in the stopping space. The vehicle charging apparatus 1 comprises a main body 2, a housing 3, a sliding body 4, a connector unit 5, a first cover 10, a second cover 20, and third covers 30 (FIGS. 1 and 2).

The main body 2 is a pedestal of the vehicle charging apparatus 1, and is fixed to the floor portion 100. The main body 2 illustrated here is formed in the form of a rectangular plate with a first direction X as a longitudinal direction and a second direction Y as a transverse direction, and is fixed to a rectangular floor portion 100 with the first direction X as the longitudinal direction and the second direction Y as the transverse direction. The vehicle charging apparatus 1 is provided with the sliding body 4 which can slide in the first direction X with respect to the main body 2.

Here, the first direction X and the second direction Y are defined on a plane of the main body 2 and the floor portion 100. A third direction Z is a direction perpendicular to each of the first direction X and the second direction Y, and is a direction perpendicular to the plane of the main body 2 and the floor portion 100. For example, in the vehicle charging apparatus 1, the vehicle may enter the floor portion 100 while moving forward or backward along the first direction X. In this case, an approach direction and an exit direction (In other words, the vehicle longitudinal direction) of the vehicle with respect to the floor portion 100 are the first direction X, a vehicle width direction is the second direction Y, and a vehicle top-and-bottom direction (i.e. the vertical direction) is the third direction Z. In addition, for example, in the vehicle charging apparatus 1, the vehicle may enter the floor portion 100 while moving forward or backward along the second direction Y. In this case, the entering direction and the leaving direction of the vehicle (in other words, the vehicle longitudinal direction) with respect to the floor portion 100 is the second direction Y, a vehicle width direction is the first direction X, and a vehicle up-and-down direction (i.e. the vertical direction) is the third direction Z.

The sliding body 4 is supported by a rail extending in the first direction X and housed in the housing 3. The rail is installed, for example, on the main body 2. The sliding body 4 can reciprocate in the first direction X along the rail, and is pulled out along the first direction X from one longitudinal side of the main body 2 or one end of the housing 3 when power is fed. The sliding body 4 comprises a base portion 41 and a frame portion 42 (FIG. 2). The base portion 41 and the frame portion 42 form a housing space 40 that houses key components of the vehicle charging apparatus 1.

The base portion 41 is a flat plate-shaped member. The frame portion 42 is fixed to an upper surface of the base portion 41. The frame portion 42 is arranged so as to surround the connector unit 5 from three sides. The frame portion 42 illustrated here comprises a pair of opposing walls 43 arranged to face each other with a gap, and a connecting wall 44 connecting end portions of the pair of opposing walls 43 (FIG. 2). In the frame portion 42, the connector unit 5 is arranged in a space surrounded by the pair of opposing walls 43 and the connecting wall 44 (i.e. in the housing space 40). The pair of opposing walls 43 each extend in the first direction X and are arranged to face each other with the gap in the second direction Y. The connecting wall 44 extends in the second direction Y and connects both ends of the pair of opposing walls 43, which are on the pull-out direction side of the sliding body 4 when power is fed.

In the following description, a motion of the sliding body 4 in the pull-out direction (here, a front side X1) along the first direction X with respect to the main body 2 is referred to as “forward motion”, and a motion of the sliding body 4 in the direction opposite to the pull-out direction (here, to a rear side X2) is referred to as “backward motion”. The sliding body 4 is forwarded toward one side in the first direction (i.e. the front side X1) when power is fed, and is retreated toward the other side in the first direction (i.e. the rear side X2) when the power feeding is completed.

The connector unit 5 is housed in the housing space 40 of the sliding body 4 when the vehicle charging apparatus 1 is in a non-operating state, such as when the vehicle is not entering the stopping space. The connector unit 5 then is pressed out of the housing space 40 from the housing position when power is fed.

The connector unit 5 comprises a connector 51 and arms 52 (FIG. 2). The connector 51 is a fitting body for power feeding to be connected to the vehicle. The connector 51 comprises a plurality of terminals connected to the vehicle-side terminals. The connector unit 5 illustrated here comprises a pair of arms 52 that sandwich the connector 51 in the second direction Y. The pair of arms 52 are arranged to face each other with a gap in the second direction Y. The pair of arms 52 then extend, for example, in the first direction X when being housed in the housing space 40. The arms 52 respectively have, at one end, a base end portion 52a swingably supported by the base portion 41. The pair of arms 52 are connected at respective base end portions 52a by a rotating shaft. The connector 51 is connected to and supported by respective distal end portions 52b at the other end of the pair of arms 52.

A motor 53 as a driving source is installed in the base portion 41 (FIG. 2). The motor 53 is connected to the rotating shaft of the base end portions 52a, and allows the arms 52 to swing. The pair of arms 52 are driven by the motor 53, and rotate around the base end portions 52a as a rotation center, thereby moving the connector 51 at the distal end portions 52b up and down. In the description below, a rotational motion of the arms 52 that move the connector 51 upwards is referred to as a “rising motion”. When performing the rising motion, the arms 52 rotate in a direction of moving the distal end portions 52b away from the base portion 41.

FIG. 2 illustrates the connector unit 5 in the middle of rising the arms 52 from the housing position to a rising position (or vice versa). That is, a rotational position of the arms 52 illustrated in FIG. 2 is located between the housing position where the connector unit 5 is housed in the housing space 40 and the rising position where the connector unit 5 is pressed out of the housing space 40. When the arms 52 are in the housing position, the connector 51 is arranged at a lowermost end of the up and down motion. In addition, when the arms 52 are in the rising position, the connector 51 is disposed at an uppermost end of the up and down motion.

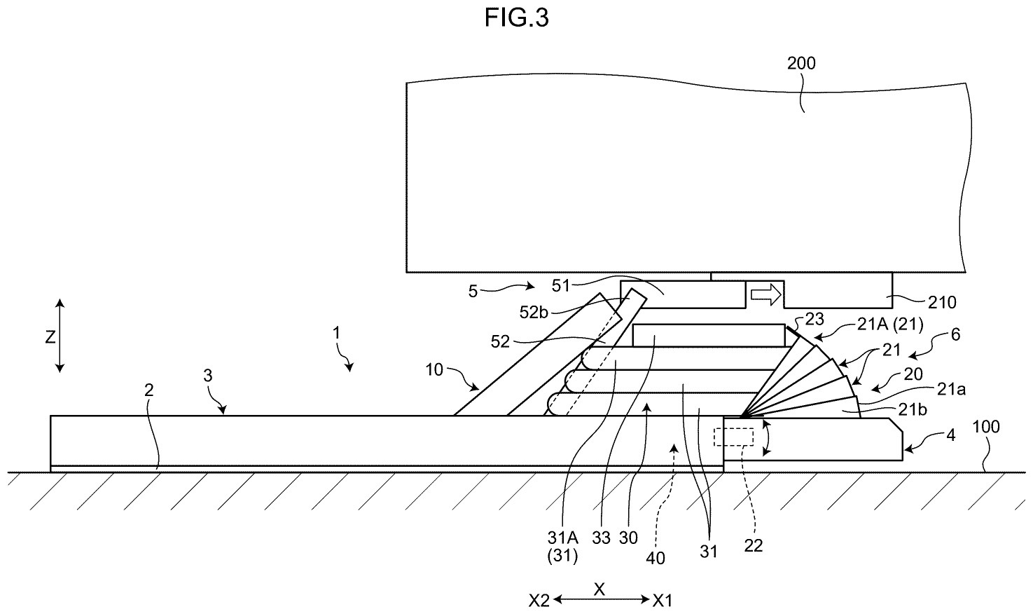

The first cover 10 covers the connector unit 5 from above with the sliding body 4 housed in the main body 2 (FIG. 1). In the first cover 10, a position covering the connector unit 5 from above is defined as a closed position. The first cover 10 is swung in conjunction with the swinging motion of the arms 52. FIG. 3 illustrates the first cover 10 when the arms 52 are in the rising position. The first cover 10 may be pushed up by the arms 52 from the closed position to the open position by the swinging motion of the arms 52 from the housing position to the rising position. In addition, the first cover 10 may be opened and closed by torque transmitted from a driving source such as the motor 53. The first cover 10 covers the arms 52 from a side opposite to the forwarding direction of the sliding body 4 (i.e. the rear side X2) while swinging in conjunction with the swinging motion of the arms 52 when the arms 52 rise. The first cover 10 covers the arms 52 from the rear side X2 when the arms 52 are in the rising position and the first cover 10 is in the open position.

The connector 51 is fitted and connected to an inlet 210 of a vehicle 200 (FIG. 3). The inlet 210 is a power receiving fitting body arranged in a lower portion of a body of the vehicle 200. The connector 51 is electrically connected to a secondary battery of the vehicle 200 by fitting and connecting the connector 51 to the inlet 210. The vehicle charging apparatus 1 comprises a sensor for detecting an inlet 210 of the vehicle stopped at the stopping space, and a control unit to which an output signal of the sensor is input. The control unit performs an operation for a relative positional relationship between the connector 51 and the inlet 210 based on the output signal of the sensor, and controls a position of the sliding body 4 with respect to the main body 2, a position of the connector 51 in an up and down direction (height position), and a posture of the connector 51 based on the operation result.

The vehicle charging apparatus 1 is provided with a movable frame 6 between the frame portion 42 of the sliding body 4 and the connector unit 5 (FIGS. 2 and 3). The movable frame 6 is provided for protecting the internal components including the connector unit 5 by reducing ingress of foreign matter or the like into the housing space 40 when power is fed. The movable frame 6 surrounds the connector unit 5 while the arms 52 are in the housing position. In addition, the movable frame 6 surrounds the arms 52 while the arms 52 are in the rising position. This movable frame 6 moves in conjunction with the swinging motion of the arms 52 when the arms 52 rise, and then surrounds the arms 52 which are in the rising position from the forwarding direction side of the sliding body 4 (i.e. the front side X1), as well as sandwiches and surrounds the arms 52 in the second direction. The movable frame 6 is configured with a second cover 20 and a pair of third covers 30. The second cover 20 and the pair of third covers 30 are configured to extend upwards in conjunction with the swinging motion of the arms 52 when the arms 52 rise, and form the movable frame 6 surrounding the arms 52 which are in the rising position. In addition, the second cover 20 and the pair of third covers 30 are configured to retract downwards in conjunction with the swinging motion of the arms 52 from the rising position to the housing position.

The second cover 20 is supported by the sliding body 4 and surrounds the connector unit 5 from the forwarding direction side of the sliding body 4. The second cover 20 comprises a plurality of overlapping constructs 21 (FIGS. 2 and 3). Each of the constructs 21 is formed in the form of a plate and is slidably assembled one another. The second cover 20 is configured to extend upwards while sliding the plurality of constructs 21 in conjunction with the swinging motion of the arms 52. The constructs 21 include a main wall 21a extending in the second direction Y and side walls 21b respectively extending in the same direction from both ends of the main wall 21a. The main wall 21a is formed in a rectangular plate shape. The main wall 21a is arranged between the connecting wall 44 of the frame portion 42 and the connector unit 5, and covers the connector unit 5 from the forwarding direction side of the sliding body 4. The pair of side walls 21b have a cantilever shape perpendicular to the main wall 21a, and are arranged to face each other with a gap in the second direction Y. The side walls 21b are arranged between the opposing walls 43 of the frame portion 42 and the connector unit 5. Each of the constructs 21 is rotatably supported at the free end of each of the side walls 21b by the sliding body 4 (e.g. the opposing walls 43 of the frame portion 42), thereby rotating around an axis in the second direction Y at its free end as the rotation center.

In the case of the second cover 20 illustrated here, each of the constructs 21 is rotated by an output torque of the motor 53. The output torque of the motor 53 is transmitted to the second cover 20 via a sprocket and a chain. Here, a rotating member 22 is interposed between the motor 53 and the second cover 20 (FIG. 3). The rotating member 22 is rotated by the output torque of the motor 53 transmitted via the sprocket and the chain, and then sequentially rotates each of the constructs 21. When rising the arms 52, the rotating member 22 is rotated in conjunction with the swinging motion of the arms 52 and each of the constructs 21 then is rotated upwards sequentially by the rotation of the rotating member 22.

A first construct 21 rotates upwards while sliding against a second construct 21. Upon the first construct 21 rising to a predetermined position, the second construct 21 begins to rotate. The second construct 21 rotates upwards while sliding against a third construct 21. Upon the second construct 21 rising to a predetermined position, the third construct 21 begins to rotate. As such, the second cover 20 is configured as a stretchable cover that expands in an arc shape as the plurality of constructs 21 sequentially rotate while sliding.

The pair of third covers 30 are arranged to face each other with a gap in the second direction Y (FIG. 2). The connector unit 5 is arranged between the pair of third covers 30. The third covers 30 are arranged between the side walls 21b of the second cover 20 and the connector unit 5. The pair of third covers 30 respectively comprise a plurality of overlapping constructs 31 (FIGS. 2 and 3). Each of the constructs 31 is formed in the form of a plate and is slidably assembled one another. The constructs 31 illustrated here are formed in the form of a rectangular plate with the first direction X as a longitudinal direction. The pair of third covers 30 are respectively configured to extend upwards while sliding the plurality of constructs 31 in conjunction with the swinging motion of the arms 52.

The third covers 30 move the constructs 31 up and down by parallel links. Each of the constructs 31 is connected to the arms 52 directly or indirectly at an end portion 31a on the rear side X2 (FIG. 2). The end portions 31a illustrated here are connected to the relevant arms 52 via links 54 parallel to the arms 52. The links 54 are connected to the relevant arms 52 arranged to face each other in the second direction Y. In addition, each of the construct 31 is connected to a link 32 at an end portion 31b on the front side (FIG. 2). The links 32 are rotatably supported by the sliding body 4 and are configured to maintain parallelism to the arms 52. The links 32 may be driven by the motor 53 so as to rotate in synchronization with the arms 52.

Each of the constructs 31 move up and down while being supported by the links 54 and the links 32. When the arms 52 perform the rising motion, each of the constructs 31 moves upwards in conjunction with the swinging motion of the arms 52. The third covers 30 thereby extend upwards while sliding each of the constructs 31. The third covers 30 are a stretchable cover extending upwards while each of the constructs 31 simultaneously rises. When the arms 52 rotate toward the housing position, each of the constructs 31 moves downwards in conjunction with the swinging motion of the arms 52. The third covers 30 thereby retract downwards while sliding each of the constructs 31.

The movable frame 6, which is one of this power feeding side components, extends the second cover 20 and the pair of third covers 30 upwards when the connector 51 is moved toward the inlet 210 of the vehicle 200. As described above, the movable frame 6 is installed for the purpose of reducing ingress of foreign matter or the like into the housing space 40 when power is fed. Thus, the movable frame 6 desirably reduces a gap between each of the upper ends of the second cover 20 and the pair of third covers 30 extending upwards and the vehicle 200, so that the movable frame 6 extends the second cover 20 and the pair of third covers 30 upwards to a position to be such a gap. On the other hand, the upper ends of the second cover 20 and the third covers 30 may come into contact with the vehicle 200 depending on a stopping posture of the vehicle 200 when the movable frame 6 extends the second cover 20 and the pair of third covers 30 upwards to a position where the gap with the vehicle 200 is narrow. For example, in the stopping space, the vehicle 200 sometimes may be stopped at an angle with respect to the first direction X, or the vehicle 200 may be stopped while being inclined in a roll motion direction or a pitch motion direction depending on boarding positions of occupants or a luggage loading position in the vehicle 200. The inlet 210 of the vehicle 200 may then follow the stopping posture of the vehicle 200, causing an inclination similar to the inclination of the vehicle 200. In this case, the upper ends of the second cover 20 and the third covers 30 may come into contact with the inclined inlet 210.

Therefore, the movable frame 6 is thus provided, at least at its upper end, with a buffer member that has flexibility and can come into contact with the vehicle 200 before the upper end. For example, a buffer member formed of synthetic rubber, e.g. in the form of a sheet, a buffer member formed of a synthetic resin material with flexibility and the like can be considered. The buffer member, for example, may be molded as a separate component and assembled to the movable frame 6. In this case, for example, the buffer member is attached to at least at the upper end of the movable frame 6, is bonded to at least at the upper end of the movable frame 6 with an adhesive or the like, or is fixed to at least at the upper end of the movable frame 6 with a screw member or the like. In addition, when the movable frame 6 is made of, for example, metal, the buffer member may be formed by insert molding in which the movable frame 6 is arranged in a mold, and when the movable frame 6 is made of synthetic resin, the buffer member may be formed by two-color molding with the movable frame 6.

Specifically, the second cover 20 is provided, at its upper end, with a first buffer member 23 that has flexibility and can come into contact with the vehicle 200 before the upper end (FIGS. 2 and 3). The first buffer member 23 is provided at the upper end of a construct 21A located at the uppermost stage in each of the constructs 21 of the second cover 20 when the second cover 20 extends upwards. The first buffer member 23 is provided at least at an upper end of the main wall 21a in the construct 21A in which the first buffer member 23 is installed. The first buffer member 23 thus may be provided at upper ends of each of the side walls 21b in addition to the upper end of the main wall 21a of the construct 21A in which the first buffer member 23 is installed.

The pair of third covers 30 are provided, at each of the upper ends, with second buffer members 33 that have flexibility and can come into contact with the vehicle 200 before the upper ends (FIGS. 2 and 3). The second buffer members 33 are provided at an upper end of the constructs 31A located at the uppermost stage in each of the constructs 31 of the third covers 30 when the third covers 30 extend upwards.

The second cover 20, when extended upwards, allows the first buffer member 23 to come into contact with the vehicle 200 side such as the inlet 210 before the uppermost construct 21A comes into contact with the vehicle 200 side. In addition, the third covers 30, when extended upwards, allow the second buffer members 33 to come into contact with the vehicle 200 side such as the inlet 210 before the uppermost constructs 31A come into contact with the vehicle 200 side. Thus, the vehicle charging apparatus 1 can protect the movable frame 6 and the vehicle 200 side such as the inlet 210, and can deter durability deterioration and functional deterioration of the movable frame 6 and the vehicle 200 side. Accordingly, the vehicle charging apparatus 1 can reduce quality deterioration of both the movable frame 6 and the vehicle 200 side.

Here, the first buffer member 23 may be provided for each of the constructs 21 of the second cover 20 so as to cover entire outer wall surfaces of the constructs 21. In addition, the second buffer members 33 may be provided for each of the constructs 31 of the third covers 30 so as to cover entire outer wall surfaces of the constructs 31. The vehicle charging apparatus 1, even if provided with such first buffer member 23 and second buffer members 33, can protect the movable frame 6 and the vehicle 200 side such as the inlet 210 as in the above example, thereby deterring durability deterioration and functional deterioration, and reducing quality deterioration of both the movable frame 6 and the vehicle 200 side.

The housing 3 comprises a fixed cover 7, a sliding cover 8, and an auxiliary cover 9 (FIG. 1). The housing 3 houses the sliding body 4 so as to cover the sliding body 4 from above and from sides. The fixed cover 7 is arranged on the rear side X2 of the main body 2, and is fixed to the main body 2 at a portion on the rear side X2. The sliding cover 8 is arranged closer to the first cover 10 than the fixed cover 7, and is connected to an end of the first cover 10 at the rear side X2. The sliding cover 8 can slide in the first direction X together with the first cover 10. The first cover 10 is connected to the sliding cover 8 via a hinge, and swings while being supported by the sliding cover 8.

The auxiliary cover 9 is arranged between the fixed cover 7 and the sliding cover 8. For example, the auxiliary cover 9 illustrated here is arranged between the fixed cover 7 and the sliding cover 8 in the first direction X, and is arranged between the fixed cover 7 and the sliding cover 8 in the third direction Z. That is, the auxiliary cover 9 overlaps the fixed cover 7 from the outside and overlaps the sliding cover 8 from the inside between the fixed cover 7 and the sliding cover 8.

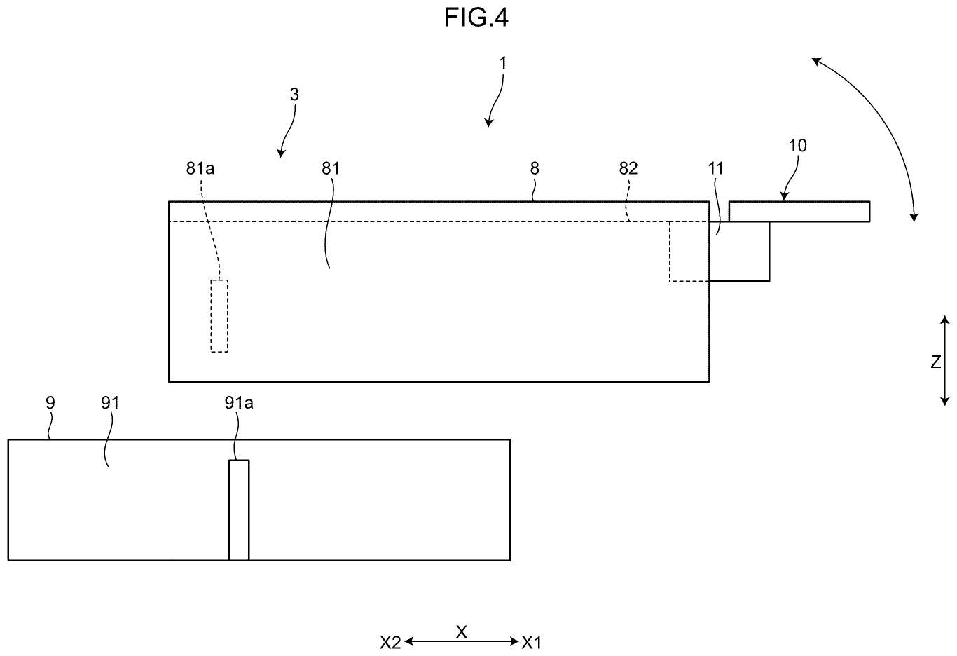

The sliding cover 8 and the auxiliary cover 9 are independent members, and can move relative to each other in the first direction X. The sliding cover 8 has side walls 81 arranged to face each other with a gap in the second direction Y (FIGS. 4 to 6). Each of the inner wall surfaces of the pair of side walls 81 is provided with a protrusion 81a. In addition, the auxiliary cover 9 has side walls 91 arranged to face each other with a gap in the second direction Y, in which outer wall surfaces are arranged to face to inner wall surfaces of the side walls 81 of the sliding cover 8 in the second direction Y. Each of the outer wall surfaces of the pair of side walls 91 is provided with a protrusion 91a that can come into contact with the protrusions 81a of sliding cover 8 (FIGS. 4 to 6). The protrusions 91a extend in the third direction Z.

The sliding cover 8 and the first cover 10 are connected by a connecting portion 11 (FIGS. 4 to 6). The connecting portion 11 comprises a hinge or the like and connects each of the sliding cover 8 and the first cover 10 such that the first cover 10 can swing with respect to the sliding cover 8. The connecting portion 11 is arranged at an end portion of a top wall 82 on the first cover 10 side (i.e. the front side X1), and is fixed to an inner wall surface of the top wall 82. The connecting portion 11 can abut on the auxiliary cover 9.

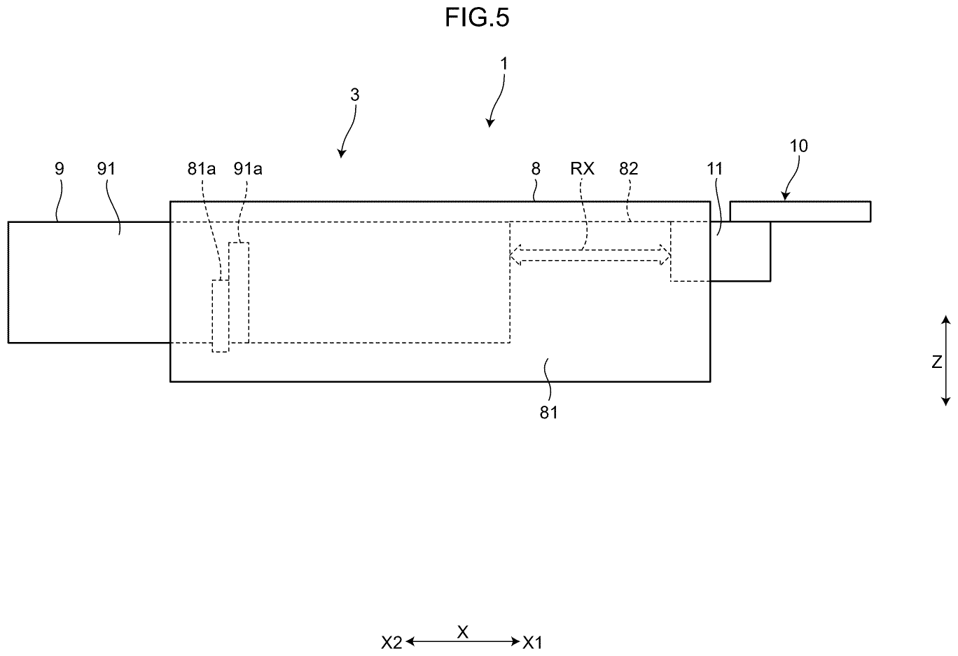

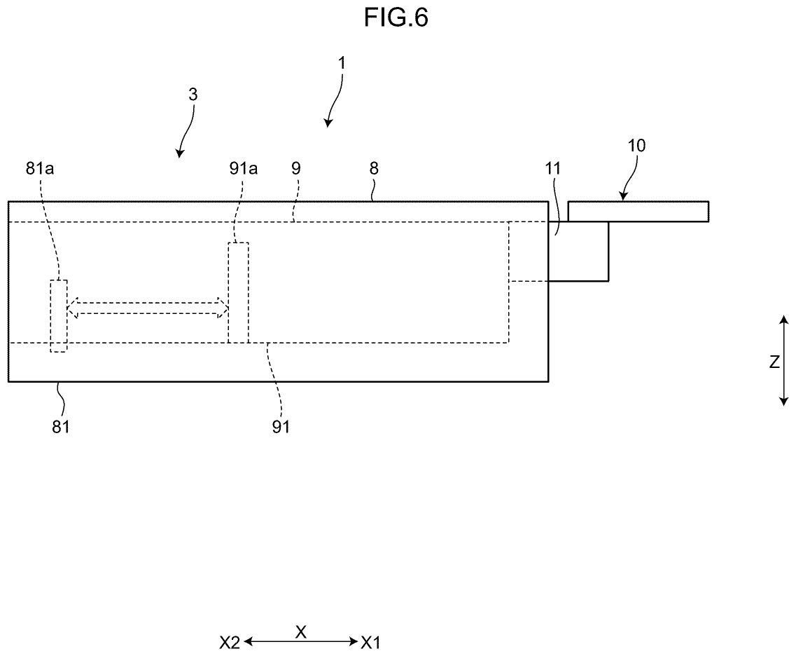

As described above, the sliding cover 8 is arranged so as to cover the auxiliary cover 9 from the outside (FIG. 5). The auxiliary cover 9 can move relative to the sliding cover 8 in the first direction X between a position illustrated in FIG. 5 and a position illustrated in FIG. 6 within a movable range RX illustrated in FIG. 5. The position of the auxiliary cover 9 illustrated in FIG. 5 is a position where the protrusions 81a and 91a abut on each other. The position of the auxiliary cover 9 illustrated in FIG. 6 is a position where an end surface of the auxiliary cover 9 in the front side X1 abuts on the connecting portion 11.

In the housing 3, the protrusions 81a and 91a abut on each other with the sliding cover 8 slid toward the front side X1 with respect to the auxiliary cover 9. When the protrusions 81a and 91a abut on each other, a part of the auxiliary cover 9 protrudes from an end of the sliding cover 8 on the rear side X2 toward the rear side X2. The auxiliary cover 9 generates no gap between the fixed cover 7 and the sliding cover 8 due to the protruding portion when the sliding cover 8 slides toward the front side X1.

Hereinafter, an operation of the vehicle charging apparatus 1 will be described.

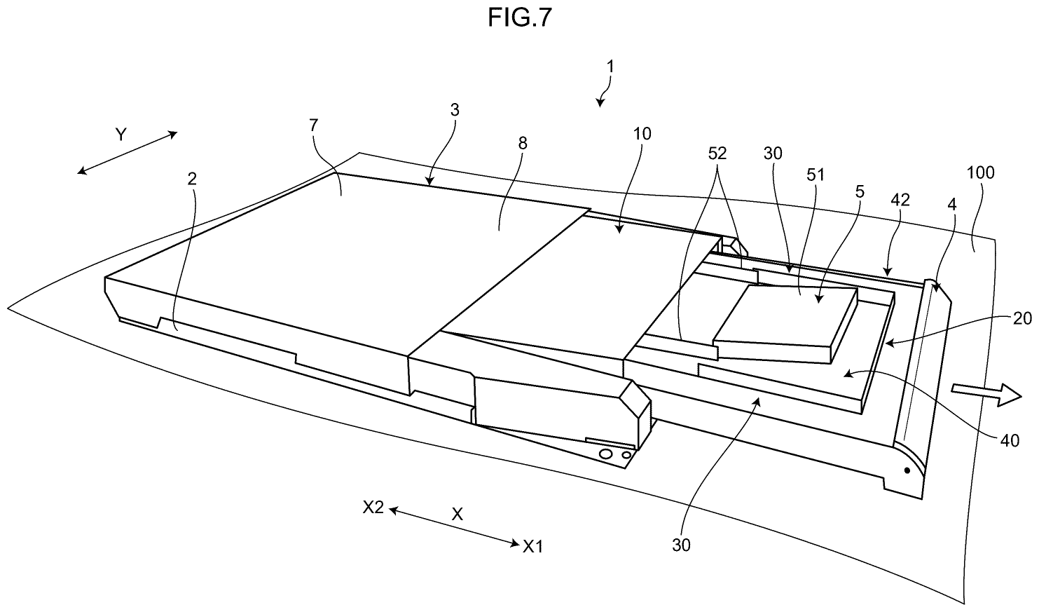

When the vehicle 200 stops on the floor portion 100 of the stopping space and begins a power feeding operation, the vehicle charging apparatus 1 moves the sliding body 4 forward to a predetermined position while sliding the sliding body 4 toward the front side X1 (FIG. 7). At this point, the first cover 10 is locked and stopped. When the sliding body 4 is moved forward to a predetermined position, the vehicle charging apparatus 1 unlocks the first cover 10. The vehicle charging apparatus 1 thereby allows the first cover 10 and the sliding cover 8 to slide together with the sliding body 4. At that time, the connector unit 5 is housed in the housing space 40 surrounded by the frame portion 42 with the arms 52 in the housing position (FIG. 7). In addition, the second cover 20 and the third covers 30 are in a retracted state and are stored inside the frame portion 42.

The vehicle charging apparatus 1 detects a position of the inlet 210 of the vehicle 200 by a sensor, and determines a target position of the sliding body 4. The vehicle charging apparatus 1 moves the sliding body 4 back and forth to the target position to position the connector unit 5 with respect to the inlet 210. When the sliding body 4 moves back and forth, the first cover 10 and the sliding cover 8 move back and forth together with the sliding body 4.

The vehicle charging apparatus 1 suspends the sliding body 4 at the target position, and then causes the arms 52 to stand and cause the connector 51 to face the inlet 210 (FIG. 3). At this point, the second cover 20 and the third covers 30 extend upwards, and form the movable frame 6 surrounding the arms 52 which is in a rising state. In addition, the movable frame 6 (the second cover 20 and the third covers 30) can initially bring the first buffer member 23 and the second buffer members 33 into contact with the vehicle 200 side, such as the inlet 210, depending on the stopping posture of the vehicle 200 with respect to the stopping space, when extended upwards. The second cover 20 is located on the front side X1 with respect to the arms 52, and reduces ingress of foreign matter from the front side X1. The third covers 30 are located on both sides in the second direction Y with respect to the arms 52, and reduce ingress of foreign matter from the sides. The first cover 10 is located on the rear side X2 with respect to the arms 52, and reduces ingress of foreign matter from the rear side X2. As such, the vehicle charging apparatus 1 of the present embodiment surrounds the arms 52 in a rising state from four sides by the first cover 10, the second cover 20, and the third covers 30, thereby reducing ingress of foreign matter or the like into the housing space 40.

The vehicle charging apparatus 1 fits the connector 51 into the inlet 210 to feed power to the secondary battery of the vehicle 200. When the power feeding to the secondary battery of the vehicle 200 is completed, the vehicle charging apparatus 1 detaches the connector 51 from the inlet 210 and moves the arms 52 to the housing position. At this point, the second cover 20 and the third covers 30 retract downwards in conjunction with the swing of the arms 52 and are stored in the housing space 40. The first cover 10 returns to the closed position in conjunction with the swing of the arms 52. When the connector unit 5, the second cover 20, and the third covers 30 are housed in the housing space 40, the vehicle charging apparatus 1 locks the first cover 10 to retract the sliding body 4, and houses the sliding body 4 in the main body 2. The vehicle charging apparatus 1 finishes the power feeding operation when the sliding body 4 moves backwards to the initial position illustrated in FIG. 1.

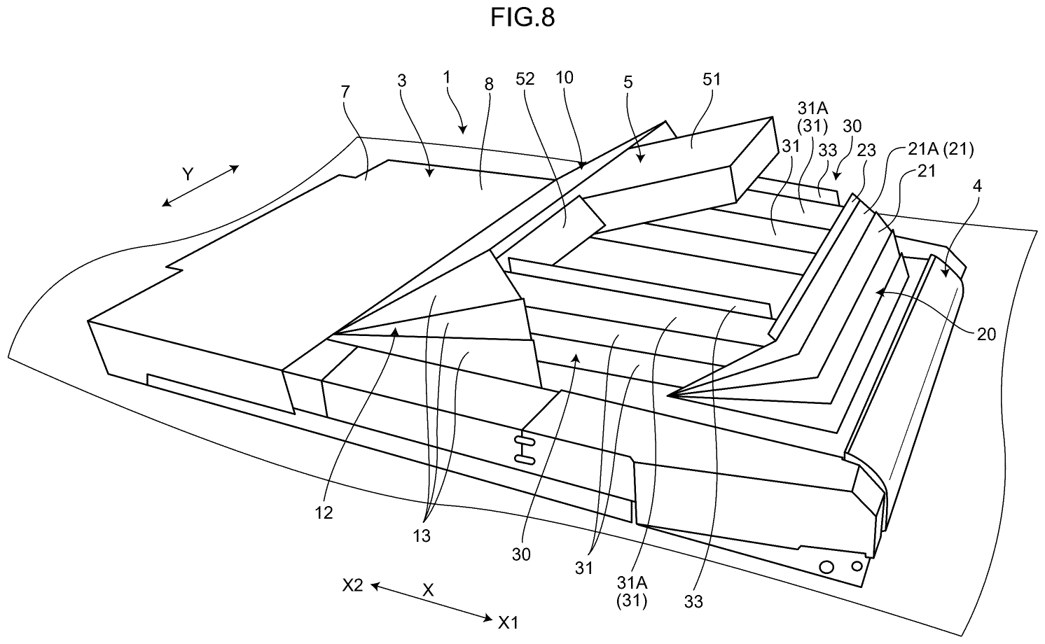

The first cover 10 may have side plate portions 12 as illustrated in FIG. 8. The side plate portions 12 cover the arms 52 from the outside in the second direction Y. The side plate portions 12 are configured with a plurality of plate members 13. The plurality of plate members 13 move upwards while sliding on each other in conjunction with the swinging motion of the arms 52. As illustrated in FIG. 8, the second cover 20 and the side plate portions 12 may be arranged outside the third covers 30 in the second direction Y.

As described above, the vehicle charging apparatus 1 of the present embodiment comprises the buffer members (first buffer member 23 and second buffer members 33) at least at the upper end of the movable frame 6 (second cover 20, third covers 30). Thus, this vehicle charging apparatus 1 can initially bring the first buffer member 23 and the second buffer members 33 into contact with the vehicle 200 side, even if the vehicle 200 side, such as an inlet 210, is misaligned depending on a stopping posture of the vehicle 200 relative to the stopping space, when the movable frame 6 (second cover 20 and third covers 30) is extended upwards. Accordingly, the vehicle charging apparatus 1 of the present embodiment can protect the movable frame 6 and the vehicle 200 side, thereby deterring durability deterioration and functional deterioration, and reducing quality deterioration of both the movable frame 6 and the vehicle 200 side.

A vehicle charging apparatus according to the present embodiment comprises buffer members (a first buffer member, second buffer members) at least at an upper end of a movable frame (a second cover, third covers). Thus, this vehicle charging apparatus can initially bring the first and second buffer members into contact with a vehicle side, even if the vehicle side, such as an inlet, is misaligned depending on a stopping posture of the vehicle relative to the stopping space, when the movable frame (the second cover and the third covers) is extended upwards. Accordingly, the vehicle charging apparatus according to the present invention can protect both the movable frame and the vehicle side, thereby deterring durability deterioration and functional deterioration, and reducing quality deterioration of both the movable frame and the vehicle side.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle charging apparatus comprising:
a main body fixed to a floor portion of a stopping space for stopping a vehicle;
a sliding body which can slide in a first direction with respect to the main body and forwards toward one side in the first direction when power is fed;
a connector unit provided with a power feeding connector to be connected to the vehicle and arms, wherein the arms are swingably supported at base end portions at one end by the sliding body and support the connector at distal end portions at another end;
a first cover that covers the connector unit from above with the sliding body housed in the main body, and covers the arms from a side opposite to a forwarding direction of the sliding body while swinging in conjunction with a swinging motion of the arms when the arms rise;
a second cover that is supported by the sliding body and surrounds the connector unit from the forwarding direction side; and
third covers that are supported by the sliding body, and respectively arranged to face each other with a gap in a second direction perpendicular to each of the first direction and a vertical direction, wherein the connector unit is arranged between the third covers, wherein
the second cover and a pair of the third covers extend upwards in conjunction with the swinging motion of the arms when the arms rise, and form a movable frame surrounding the arms which are in a rising position,
the second cover is provided, at least at an upper end of the second cover, with a first buffer member that has flexibility and can come into contact with the vehicle before the upper end, and
the pair of third covers are provided, at least at respective upper ends of the third covers, with a second buffer members that have flexibility and can come into contact with the vehicle before the upper ends.

2. The vehicle charging apparatus according to claim 1, wherein
the second cover and the pair of third covers each comprise a plurality of plate-like constructs overlapping each other, and are configured to extend upwards while sliding the plurality of constructs in conjunction with the swinging motion of the arms,
the first buffer member is provided at an upper end of the construct positioned at an uppermost stage when the second cover is extended upwards in each of the constructs of the second cover, and
the second buffer members are provided at an upper end of the constructs positioned at an uppermost stage when the third covers are extended upwards in each of the constructs of the third covers.

3. The vehicle charging apparatus according to claim 1, wherein
the second cover and the pair of third covers each comprise a plurality of plate-like constructs overlapping each other, and are configured to extend upwards while sliding the plurality of constructs in conjunction with the swinging motion of the arms,
the first buffer member is provided for each of the constructs of the second cover so as to cover entire outer wall surfaces of the constructs, and
the second buffer members are provided for each of the constructs of the third covers so as to cover entire outer wall surfaces of the constructs.
